(19) United States
(12) Patent Application Publication
(10) Pub. No.: US 2014/0151466 A1
(43) Pub. Date: Jun. 5, 2014

(54) SHOWER WITH DETACHABLE FACEPLATE

(71) Applicant: Kylin Sanitary Technology (Xiamen) Co., Ltd., Fujian Province (CN)

(72) Inventors: Kyle William CUTLER, Fujian Province (CN); Qingshuang Li, Fujian Province (CN); Mengshi Guo, Fujian Province (CN); Chonggen Chen, Fujian Province (CN)

(73) Assignee: Kylin Sanitary Technology (Xiamen) Co., Ltd., Fujian Province (CN)

(21) Appl. No.: 14/033,438

(22) Filed: Sep. 21, 2013

(30) Foreign Application Priority Data
Dec. 4, 2012 (CN) 201220656833.X

(51) Int. Cl. B05B 1/18

(52) U.S. Cl. CPC B05B 1/185
USPC 239/548

(57) ABSTRACT

This invention discloses a shower that comprises a detachable faceplate, a body with chamber assembly inside, a water diverter and a back plate mounted in the chamber assembly. Slots are arranged to the outer circle of the said back plate. Claws are arranged to the outer circle of the said face plate which engages with the said slots of the back plate by rotation. A locking button is arranged on the said body to control the rotation of the said faceplate. The shower with a detachable faceplate mentioned in the present invention controls the rotation of faceplate by setting the locking button, to avoid the falling off caused by the free rotation of faceplate and improper operation of consumers; and the faceplate can be easily removed just by pressing the locking button to release the rotation limit and turning the faceplate gently. The shower with detachable faceplate as claimed in the subject invention not only allows consumers to lock and remove the faceplate easily, but also to prevent the faceplate from falling off after locking. Simple in structure yet convenient to use, these are the key features of the shower.

### BACKGROUND OF THE INVENTION

This invention relates to a shower, more particularly, the shower with detachable faceplate.

The Shower, also called showerhead, mainly installed in the bathroom for the shower. Most of faceplates still have fixed structure in the shower in current market. It is not convenient to use as there are lots of impurities retained in the showerhead which is unable to clean by removing the faceplate when used for a time. For some improved shower, the design of its faceplate is detachable. But it is not very convenient as generally requires a larger force to close and more force to remove. In particular to those people with less effort, they cannot open the faceplate to clean the inner of shower.

### BRIEF SUMMARY OF THE INVENTION

This invention is to provide a shower with detachable faceplate and to solve the existing inconvenient removable problem of faceplate.

To achieve the above objects, the invention includes:

A shower with detachable faceplate, including body which has an assembly chamber inside, a water diverter and a back plate mounted in the assembly chamber and a detachable faceplate, characterized in that as claimed above, the slots are arranged to the outer circle of the said back plate; claws are arranged to the outer circle of the said face plate which engages with the said slots of the back plate by rotation; a locking button is arranged on the said body to control the rotation of the said faceplate.

Additionally, the character of the shower with detachable faceplate is that: the said locking button containing gear block, button and some reset springs. The said gear block is fixed in the gear slot which in the said back plate and partially pokes up above the slots through the scaleable spring. One end of the said button is fixed in the outer edge of the said slots through the reset spring, and the other end extrudes from the button hole of the side of the said body to form the button surface.

Additionally, the portion of the said gear block lies to the said slots has a slant.

Additionally, the said button surface and the external surface of the said body have the same shape.

Additionally, both the said slot and claws are four, and one of claws has a slant.

Additionally, the said back plate is fixed in the said assembly chamber through screws.

Compared with the existing technology, the advantages of the present invention is:

The shower with detachable faceplate mentioned in the present invention controls the rotation of faceplate by setting the locking button, to avoid the falling off due to the free rotation of faceplate, and wrong operation by consumers during use; and only need to press the button of locking button to open the faceplate which removing the rotation limit of the locking button to the faceplate, then gently rotate the faceplate to open it. The shower with detachable faceplate as claimed in the subject invention not only easy and efficient to open and close the faceplate but the faceplate is not easy to fall off after closing, characterized in that simple structure and convenient use.

### BRIEF DESCRIPTION OF THE DRAWINGS

FIG. 1 is an overall schematic view of the structure of a preferred embodiment of the present invention;

FIG. 2 is segment schematic view of a preferred embodiment of this invention;

FIG. 3 is schematic view of assembly of a locking structure of this invention.

FIGS. 4a and 4b is a diagrammatic cross-section view of a preferred embodiment of faceplate rotation of this invention;

### DETAILED DESCRIPTION OF THE INVENTION

Below in conjunction with the accompanying drawings for a detailed description of specific embodiments of the present invention is to provide.

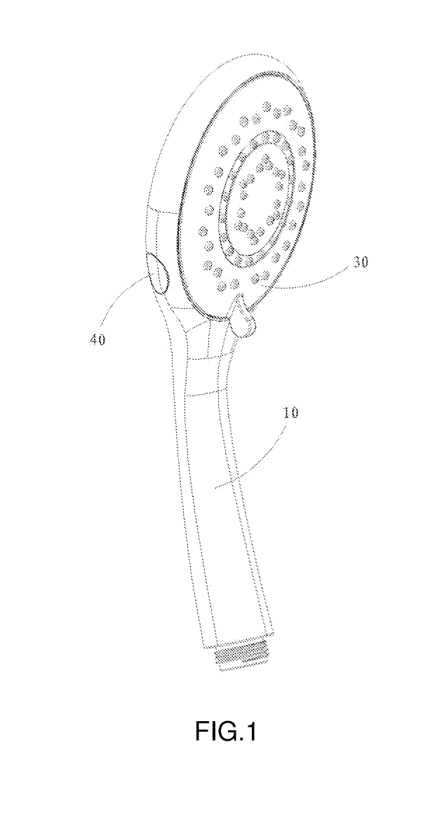

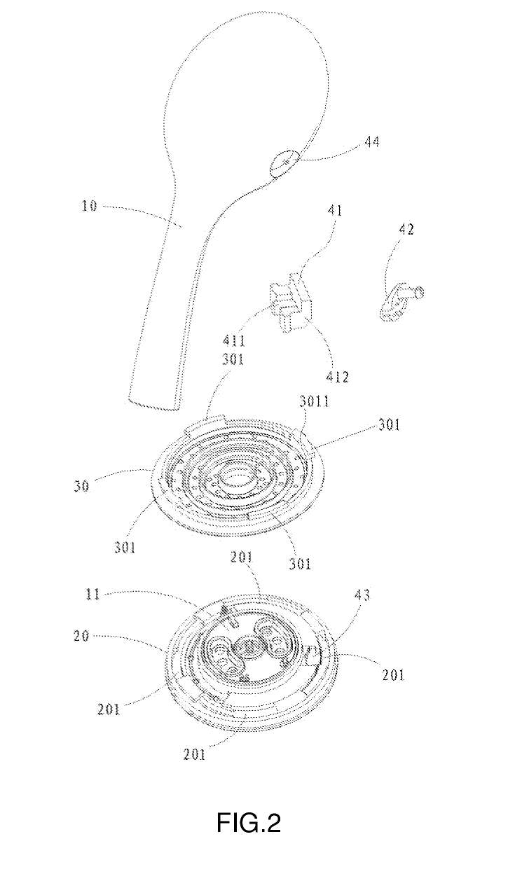

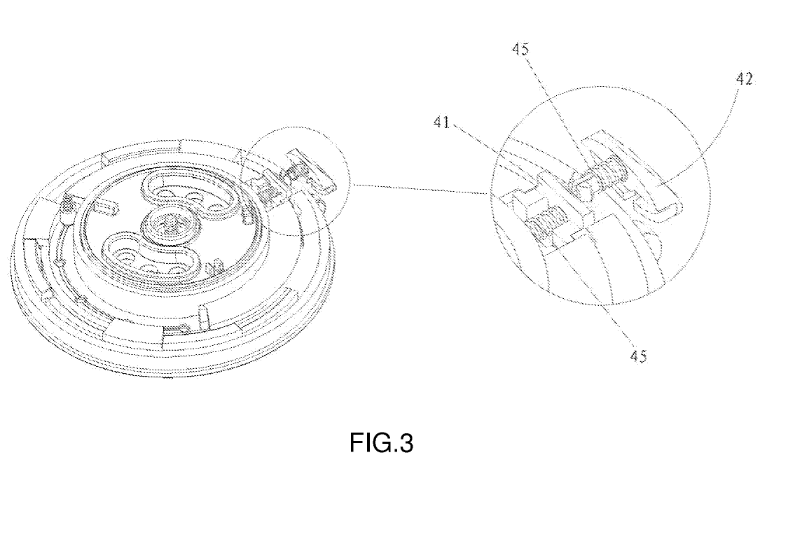

FIG. 1 is an overall schematic view of the structure of a preferred embodiment of the present invention; FIG. 2 is a segment schematic view of a preferred embodiment of this invention; FIG. 3 is a schematic view of assembly of a locking structure of this invention. Conjunction with FIG. 1, FIG. 2 and FIG. 3, a shower with detachable faceplate, including a body equipped with an assembly chamber 10, a diverter 11, a back plate 20 and a removable faceplate 30. The said diverter 11 superposed on the back plate 20, and fixed to the assembly chamber of body 10.

The said outer circle of the back plate 20 is set with slots 201; as claimed above, the outer circle of faceplate 30 is set with the rotating claws 301 engaging with the claimed slots 201 wherein a plurality of slots 201 and claws 301 can be provided, just one-to-one correspondence, and is preferably four; while the claw 301, wherein one having a bevel 3011. The bevel 3011 is formed by the claw 301 engaging with the plane of the slot 201 through cutting its inner side of the front end to the inner side of rear end.

The said body 10 is provided with a locking button 40 to limit the said faceplate 30 to rotate.

The said locking button 40 includes a gear block 41, button 42 and a plurality of the reset spring 45; after the gear lever 411 of the said gear block 41 fits the reset spring 45, the overall engaging disposed in the gear slot 43 of the back plate 20 and under the action of the reset spring 45, some parts poke up above the said slot 201.

One end of the said button 42 is fixed to the outside of the slot 201 by a reset spring 45, the other end poke up above the button hole 44 of body 10 to form the button surface. According to the actual needs, the undercut rib can be added to the said button 42 to reinforce the fixity of button hole 44 in the body and to prevent loss.

The said gear block 41 is positioned in the said slot 201 having a slant 412. The said slant 412 is facing the slot 201. When assemble the faceplate 30, the bevel 3011 on the claw 301 of the said faceplate is facing to the slant 412 of block 41 to reduce the resistance by gear block 41 to claws 301, that is to reduce the force of closing the faceplate 30 and make the closing easily.

The said button surface and the external surface of the said body 10 have the same shape, that is, the button surface fits shape of body 10 well, not only does not ruin the overall aesthetics of the shower, and not interfere with the normal use of showers.

The said back plate 20 is fixed to the assembly chamber of said body 10 passing through screws.

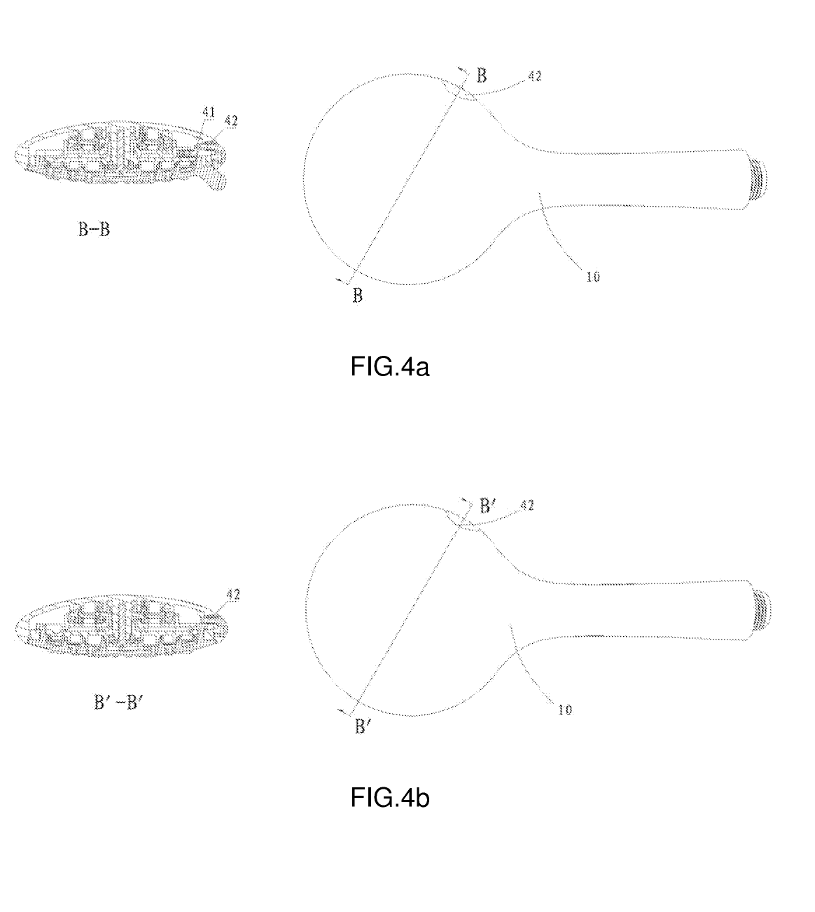

The use of the shower with detachable faceplate as said in the preferred embodiment of the present invention is as follows: when faceplate 30 is closed, pressing the said claw 301 and the slot 201 on the back plate 20 after aligning them. The bevel 3011 of claw 301 is straight at the slant 412 of gear block 41 to keep the gear block 41 on. And then rotate it to the extreme position. That is rotating the faceplate 30 to drive the back plate 20 to rotate to the gear block on the back plate 20 and stop at the body 10, and then continues to rotate the faceplate 30 till the claw 301 on the faceplate 30 tightly engaging with the back plate 20. When the faceplate 30 is removed, the faceplate 30 is rotate to the limit position of gear that is the rotation of the faceplate 30 is to drive the back plate 20 to the back plate 20, relative to a standstill of the body 20. Then make further rotation of the faceplate 30 to the claw 301 and stop at the gear block 41, press the button 42 to make the gear block 41 back, and then rotate the faceplate 30 slightly, which have the claw 301 aim at the outlet of the slot 201 then detach the faceplate 30. FIGS. 4a and 4b are the schematic sectional view to show if the rotation is reach to the limit position during the rotation of faceplate, wherein FIG. 4a shows the situation of the faceplate switches to the limit position of gear, seen from the sectional view B-B, the gear block 41 aligns the button 42 at the moment; FIG. 4b shows the situation of the faceplate not switch to the limit position, the sectional view B-B is visible, the gear block is not align with the button 42. The faceplate cannot be opened at the moment.

The shower with detachable faceplate mentioned in the present invention controls the rotation of faceplate by setting the locking button, to avoid the falling off due to the free rotation of faceplate, and wrong operation by consumers during use; and only need to press the button of locking button to open the faceplate which removing the rotation limit of the locking button to the faceplate, then gently rotate the faceplate to open it. The shower with detachable faceplate as claimed in the subject invention not only easy and efficient to open and close the faceplate but the faceplate is not easy to fall off after closing, characterized in that simple structure and convenient use which is fit for the use of broad masses.

Although the present invention to be disclosed as above with preferred embodiments, it is not intended to limit the present invention. Any person skilled in the art without departing from the spirit and scope of the invention can make possible changes and modifications. Therefore, the protection scope of this invention is subject to the scope of claims.

What is claimed is:

1. A shower with detachable faceplate, including body which has an assembly chamber inside, a water diverter and a back plate mounted in the assembly chamber and a detachable faceplate, characterized in that as claimed above, the slots are arranged to the outer circle of the said back plate; claws are arranged to the outer circle of the said face plate which engages with the said slots of the back plate by rotation; a locking button is arranged on the said body to control the rotation of the said faceplate.

2. According to claim 1, the character of the shower with detachable faceplate is that:
the said locking button containing gear block, button and some reset springs; said gear block is fixed in the gear slot which in the said back plate and partially pokes up above the slots through the scaleable spring; one end of said button is fixed in the outer edge of said slots through the reset spring, and the other end extrudes from the button hole of the side of said body to form the button surface.

3. According to claim 2, the character of the shower with detachable faceplate is that:
the portion of the said gear block lies to the said slots has a slant.

4. According to claim 2, the character of the shower with detachable faceplate is that:
the said button surface and the external surface of the said body have the same shape.

5. According to claim 1, the character of the shower with detachable faceplate is that:
both the said slots and claws are four, and one of claws has a slant.

6. According to claim 2, the character of the shower with detachable faceplate is that:
both the said slots and claws are four, and one of claws has a slant.

7. According to claim 1, the character of the shower with detachable faceplate is that:
the said back plate is fixed in the said assembly chamber through screws.
